(19) United States
(12) Patent Application Publication
(10) Pub. No.: US 2007/0184408 A1
(43) Pub. Date: Aug. 9, 2007

(54) Dental preparation instrument

(76) Inventor: Ralf Volle, Bad Liebenzell (DE)

Correspondence Address: KLAUS J. BACH, 4407 TWIN OAKS DRIVE, MURRYSVILLE, PA, 15668, US

(21) Appl. No.: 11/499,967

(22) Filed: Aug. 7, 2006

(30) Foreign Application Priority Data
Aug. 6, 2005 (DE) 10 2005 037.2

(51) Int. Cl. A61C 3/02

(52) U.S. Cl. 433/165

(57) ABSTRACT

In a dental preparation instrument consisting of a shaft part and an adjacent operating part of a configuration with cutting areas for the preparation of a tooth, wherein the front end area of the operating part comprises a surface areas of non-cutting configuration in the form which, at least in a front view, is a center circle with a diameter of a fraction of the diameter of the operating part at the transition area thereof to the front end area, the non-cutting surface area and the adjacent area of cutting configuration are steplessly fading into one another.

### BACKGROUND OF THE INVENTION

The invention resides in a dental preparation instrument with a cutting structure configured and adapted to the preparation of a tooth.

Such instruments are used for grinding a tooth in order to prepare the tooth to serve as a stump for example for supporting a crown. To this end, they have correspondingly small dimensions, for example, a diameter in the lower single-digit millimeter range, and, consequently, an almost needle shaped appearance. In these preparations as transition from the prepared tooth stump to the unprepared toothneck, depending on the kind of crown, a hollow groove or an L-shaped shoulder is formed. To this end, a so-called working part in the form of a cylinder or a forwardly tapered cone, which is provided with a grinding means or with cutters is connected to an instrument shaft adapted for chucking into a rotational drive. The respective free front end may be for example round, flat=angled or, respectively, flat with rounded edges or of a torpedo-like shape. In the latter case, it has either, as a so-called classic torpedo, a slightly outwardly curved that is a convex curved, relatively flat end tip or a cone-like pointed end tip. The classic torpedo shape with its softly rounded contour is preferred for the formation of a groove-like transition which is softly contoured in a complementary way. Herein, such a groove to be formed all around a tooth is very difficult to prepare, that is only with a large amount of experience and flair, since here, the preparation instrument in the form in which a cutting structure extends up to its tip is hand-held without support so that the gum is at risk to be injured. As a result, the preparation result is often unsatisfactory wherein a corrections can be performed only by further grinding down the tooth stump which narrows down conically upwardly and which as a result is weakened thereby.

It is also possible that, by an unwanted deeper sideward penetration of the tool with a cutting structure extending over the whole tool area into the tooth flank up to beyond the longitudinal instrument axis, a chamfer may be formed at the end of the groove. It would have to be removed by breaking with an additional tool whereby the prepared groove may again be damaged.

Also, the configuration of the groove is at risk of being damaged by the preparation instrument itself during the tooth stamp preparation, since it can be destroyed by its sliding off or by being moved too far downwardly as a result of its pointed cutter end. Furthermore, there is the great danger of injuring the gum when it is contacted by the cutting structure of the torpedo trip which is difficult to avoid so that blooding may occur during the preparation which again could obstruct the view.

Such an improvement is said to be obtained by a very thin guide pin as it is known for example from DE 299 02 114 U1 and DE 299 06 370 U1. Such a pin extends the front end of the instrument operating part and is at least at the front end of non-cutting configuration. Handling of the preparation instrument provided therewith is said to be facilitated as this pin can be guided during tooth stump preparation below the gum seam along the tooth neck in order to prevent the instrument operating part from moving too far into the tooth flank. This however is problematic with patients with healthy gums, that is, without gum pockets since the guide pin may cause painful separation of gum from the tooth neck.

On the other hand, with such a guide pin, the cutting depth in sideward direction is limited, since, because of the pin, it cannot be larger than the difference between the radius of the operating part and the radius of the guide pin. In this way, for example, possible shape corrections during the tooth stump preparation, also for example in the sense of an equalization, is impossible.

Furthermore, such a guide pin to be moved along the tooth neck transmits the unevenness of the toothneck to the contour of the tooth stump being prepared.

DE 202 11 248 U1 discloses a dental instrument wherein the whole front end of the operating part which is slightly conical and has a rounded tip, is non-cutting, that is, for example, free of any grinding means and only the rearwardly adjacent operating area has a cutting configuration, that is for example a coating of a grinding medium, in order to facilitate in this way the guiding of the instrument during the tooth preparation. Because of the absence of a grinding medium coating in the area of the rounded front end of the operating part, no transition groove can be formed with this instrument. Consequently, this instrument is suitable only for a so-called tangential preparation.

Instead of forming a preparation instrument with a groove and a torpedo-shaped end, it may be necessary for certain tooth crowns to provide an L-shaped stump preparation as a transition from the prepared tooth stump to the unprepared neck. To this end, the already mentioned instruments are used which are rounded at the front ends of the operating part or have a planar front end with squared or rounded edges.

They may also be used for the preparation of a so-called box in a tooth for the reception of an inlay. For the final preparation of the side walls of the box, the whole planar front area of the for example cylindrical operating tip of the instrument used for that purpose cannot have a cutting structure in order to avoid the undesired removal of tooth material at the bottom of the box. An instrument designed in this way can also be used during the final operation of an L-shaped step preparation.

It is the object of the present invention to improve the instrument for preparing a tooth stump.

### SUMMARY OF THE INVENION

The invention is based on the idea of facilitating the handling of instruments used particularly for the transition preparations explained above, and to improve the preparation result in that—at the very small dimensions—the instruments are provided with miniaturized non-cutting surface areas. Those are in the form of, at least in a front view, a centered circular area at the front end in the front area of the instrument operating part, wherein the diameter of the central circular area corresponds to a fraction of the diameter of the operating part at the point of transition to its front end area. This circular area and the adjacent surface area with cutting structures fade into one another.

With this division of the operating areas according to the invention, at the free front end of the preparation tool, in a small-non-cutting area which is barely noticeable with the naked eye and an adjacent cutter area which is much longer in comparison with the non-cutting area, the formation of a groove and of an L-shaped step on a tooth to be prepared is not detrimentally affected nor is it made more difficult. Since, because of the defined size ratio of cutting to non-cutting area parts of this operating area, tooth material can be removed with the latter, for example, in the curved torpedo tip area of a groove preparation instrument or at the planar front area edges of a step preparation instrument until the respective cutting area comes in contact with a tooth area which is already contoured or at the beginning of forming a groove-shaped or L-step shaped contour. Only at this contact point, a further removal of tooth material is prevented if the operating orientation of the instrument remains unchanged.

On the other hand, in radial direction, further tooth material can again be cut by the cutting area of the operating part provided with a torpedo end tip after a vertical upward movement of the instrument. This is because with this movement, the central non-cutting area has lost contact with the tooth shoulder which has already been at least partially prepared and can no longer prevent further removal of tooth material. Tooth material can then be removed until sufficient material has been removed by the abrasive surface area so that the torpedo tip comes again into contact with the tooth shoulder in a correspondingly higher location.

With this combination of non-cutting central and cutting adjacent surface areas in the front-end operating area, a very accurate working in the preparation of grooves or, respectively, step transitions is facilitated. In particular, with a torpedo tip of an operating part according to the invention, for the preparation of a groove, the instrument center axis can no longer be exceeded: Before this would happen, the non-cutting central tip area stops this sidewardly directed movement so that no further tooth material is removed and further movement into the tooth flank is prevented.

Once a tooth is ground down over its whole circumference by a back and forth oscillating or sliding movement of the preparation instrument for a definition of the position of the preparation limit and is consequently at the same time also slightly ground so as to form an initial groove, then the preparation instrument finds guidance in the row contour already formed for the further tooth material removal over the whole tooth circumference. In this connection, the non-cutting, that is, the abrasive-free smooth or possibly even polished area for example of a torpedo tip on one hand, permits the removal of tooth material along the previously defined preparation limit while being easy on the gum and forming a kind of level line without causing damage to the adjacent gum seam. During this procedure, as already mentioned, a locally excessive radial movement into the tooth flank is prevented because of the non-cutting center part of the preparation tool causes stopping of such a movement at the end of the groove being formed as it comes into contact with the tooth.

Furthermore, a groove contour which has already been prepared cannot again be destroyed since the torpedo tip preferably used for the formation thereof is, in accordance with the invention, provided with a non-cutting center area and, in this way, prevents the engagement of the remaining tip surface area with a cutting structure with the groove contour.

As a result, the central non-cutting surface area provides for a guiding of the preparation instrument during the operating procedures following the definition of the position of the preparation limit for the completion of the groove so that subsequently the proper contour can be slowly formed. The contour is protected even during a possible sliding off of the preparation tool since also then a contact with the cutting surface area is prevented by the quasi pre-positioned non-cutting center surface area of the front part of the operating part.

This non-cutting center surface area represents therefore a guide areas which assists in guiding the preparation instrument the tooth along while the groove or step contour is slowly formed around the tooth stump.

At the same time, the guide structure assists the person handling the preparation instrument. Furthermore, the non-cutting front area in the form of a torpedo tip or a step preparation instrument with a rounded tip also facilitates the sliding of the instrument on the tooth material. This again provides for an occasional instrument support during the preparation procedure.

In spite of the non-cutting surface area, the preparation limit and, consequently, the groove may be corrected anytime by a renewed deeper introduction of the preparation instrument beyond the lower edge of a groove which is already partially formed since, there again, the outer cutting surface area of for example the torpedo tip comes in contact with the tooth while the non-cutting central, that is the inner, surface area is first in a position in front of the tooth flank in which it cannot come into contact with the tooth.

Furthermore, other than, for example, with the known, initially mentioned guide pin, is possible during the preparation of a groove, to achieve, as seen in radial direction, different removal depths with only one operating part diameter. However, as already mentioned, additional tooth material can be removed starting out at the upper part thereof, for example, by a corresponding retraction of the preparation instrument according to the invention. In this way, the groove is formed deeper into the tooth stump. As a result, an otherwise necessary change-over to a preparation instrument with greater diameter is not needed for the removal of additional tooth material and consequently preparation time is saved.

By this central surface area of non-cutting configuration, the preparation instrument can also be moved at any desired level along the tooth while avoiding damage to the gum in contrast to the guide pin disclosed in cited stats of the art, whose insertion depth is limited by the depth of the gum pockets present.

A preparation tool formed in accordance with the invention can advantageously be used at locations, which are difficult to observe since the circumferential groove can be formed quite uniformly because of the guide properties of the central non-cutting surface area at the front end of the operating tip. The hollow groove is formed quasi-automatically so that care must only be taken that the provided course of the preparation limit along a caution height line extending around the tooth neck is maintained.

The guide surface area which in accordance with the invention is non-cutting cannot only be formed on preparation instruments with a cylindrical operating part of any diameter and with a basically curved or cone-like torpedo shape but also on conical operating components with free front ends which are also torpedo-shaped as well as on the front end surfaces of cylindrical operating parts of any diameter and any tip configuration.

In this connection, it is important whether the central surface areas of non-cutting configuration are integrated into the unfinished instrument body, whether they are welded, cemented or otherwise mounted and also of which material they consist.

What was said before concerning preparation instruments with torpedo-shaped front end operating tip applies correspondingly also to preparation instruments provided for the preparation of an L-shaped step forming a transition feom a prepared tooth stump to unprepared tooth neck. To this end, they have for example at the tip of the operating part a planar front surface area in whose center a non-cutting circular area is formed which fades steplessly into the adjacent annular front face area which forms a cutting surface.

Such a step preparation instrument however may also include an operating point in a round cylindrical form. That is, its free front end does not end in a planar front surface area but, because of a correspondingly rounded front area edge, it is more or less extensively rounded or fully rounded. If appropriate, the front end may even have the shape of a semi-sphere.

In the center of this rounded free front end of the operating part, a surface area is provided which, at least in a front end view, is annular and which is non-cutting.

With a step preparation instrument formed in this way, step-like transitions can also be formed in a well controllable manner in that the non-cutting central front surface area prevents a non-uniformly deep removal of tooth material on the short leg of the L-shaped transition along the tooth circumference. If the central front end area comes into contact with a leg section already formed, a further removal of tooth material is only prevented if the instrument is exactly vertically oriented. If, on the other hand, it is held in an inclined position, a cutting edge area of the front face comes into contact with a leg area which immediately results in the removal of tooth material. This is an always present danger which means that the step preparations instruments which must be guided freely by hand require a greater concentration during their use than the instruments with torpedo-shaped operating end parts used for the preparation of the grooves.

Such step preparation instruments may also be used for the preparation of an inlay base structure. In this case, the central non-cutting front surface area prevents a possible differently deep movement of the front surface area into the bottom of the box structure or, respectively, it assists in the planar formation by removal of bottom unevenness by forming a uniform bottom surface level.

Below three examples of dental preparation instruments according to the invention will be described in greater detail on the basis of schematic drawings:

### BRIEF DESCRIPTION OF THE DRAWINGS

It is shown in an about 20-fold enlargement in:

FIG. 1 the side view of a groove preparation instrument in the form “classic torpedo”,

FIG. 2 a top view of the front end of the instrument according to FIG. 1;

FIG. 3 the side view of a step-preparation instrument in the form “round cylinder”;

FIG. 4 a top view of the front end of the instrument according to FIG. 3,

FIG. 5 a side view of another step preparation instrument in the form flat cylinder, edge rounded”, and

FIG. 6 a top view of the instrument according to FIG. 5.

### DESCRIPTION OF PARTICULAR EMBODIMENTS

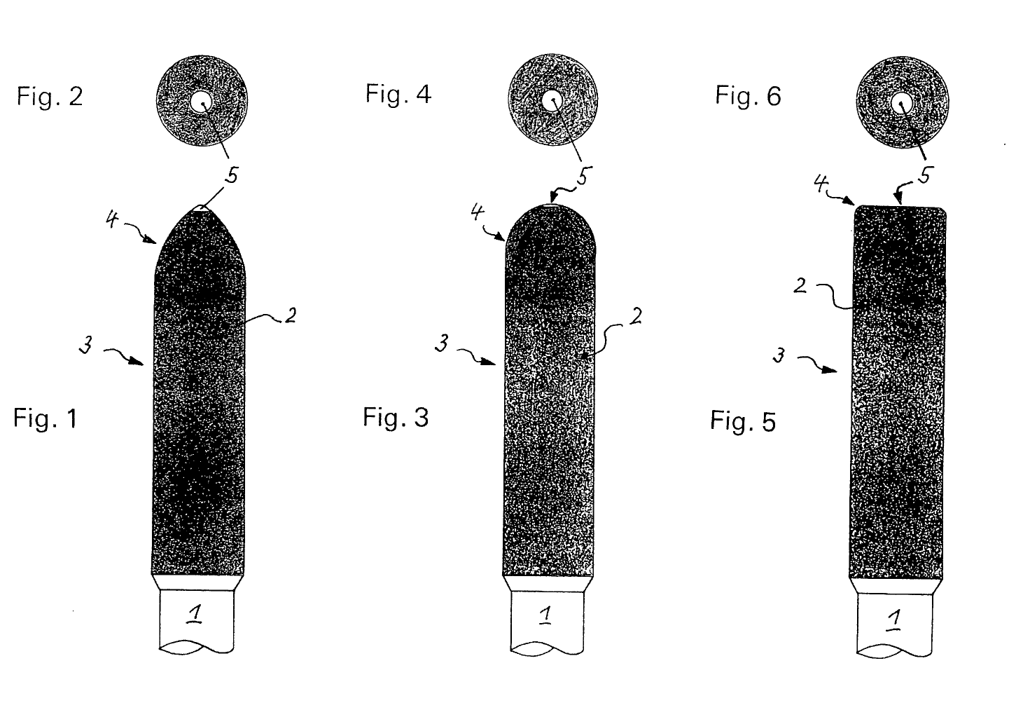

The dental preparation instruments shown in FIGS. 1, 3, and 5 particularly for groove-or-step and possibly for inlay box preparations each have a cylindrical clamping shaft 1 and an adjacent operating part 3 provided with a grinding means 2 which is indicated in the figures by a dark area, for example, with diamond splinters or hard metal splinters which operating part 3 is also cylindrical. Its free front end 4 is shaped in various ways depending on the purpose of the respective instrument.

In the “torpedo” embodiment as shown in FIG. 1, the instrument has the form of an outwardly curved that is a convex relatively flat end tip, in contrast to a known shape which includes a cone-like pointed tip. In the instrument shown in FIG. 3, the tip is rounded and in FIG. 5, the tip has a planar front surface area with rounded front edges. The two instruments are actually used in accordance with these configurations.

At the front end, or, respectively the front end area 4 of the working part 3 of the shown three instruments, there is, in each case, in the center a surface area 5 which as shown in FIGS. 2, 4, and 6 appears in a top view as a circular area 5 which is non-cutting, that is, it is not provided with grinding means. In the shown torpedo configuration (FIG. 1) or respectively, rounded cylinder configuration (FIG. 3), the area 5 has at least approximately the shape of a sphered cover. In the “cylinder flat edge rounded” configuration (FIG. 5), the area 5 is in the form of a circular area. However, because of the cylindrical shape of the operating part 3 of the instrument and the flush embodiment into the front face of the cylindrical operating part (3) which is provided with grinding means, that is, at the level of the grinding means coating 2, it is not visible in the side view of FIG. 5.

For establishing the areas 5, which are free of any grinding means for example in the torpedo configuration (FIG. 1), the circumferential area of the operating part, after a line defining the limit of the surface area 5 which is to remain free of grinding means, is cut down slightly over the whole remaining length of the operating part 3 for the application of the grinding means coating 2. The grinding means coating extends from the line cut flush with the surface area 5 at the same level of the surface area 5 so that the areas fade into one another and the instrument can be used without obstacle.

In a similar way, the non-cutting surface area 5 is formed at the front end 4 of the operating part 3 in connection with “cylinder round” configuration shown in FIG. 3. Because of its smaller curvature in comparison with the “torpedo” configuration, the surface area 5 is barely visible in FIG. 3 in spite of a 20-fold amplification.

In the “cylinder flat” configuration (FIG. 5), the front area is cut down by an amount corresponding to height of the grinding means coating 2 except for the central non-cutting surface area 5, which then forms a projection in the center of the front face area, which is flush with the grinding means coat after its application. In this way, also in this case, the formation of a step is prevented.

The surface area 5 forms a guide surface for guiding the preparation instrument first along the preparation limit formed provisionally by grinding down the tooth stump of the tooth in preparation for the application of a crown along a preparation limit line over its circumference and then along the groove formed increasingly more noticeably at the circumference of the tooth by following with the torpedo first the preparation limit line and then the groove being gradually formed or the step when using the two step preparation instruments according to FIGS. 3 and 5.

The diameter of the central grinding means-free circular area 5 is only a fraction of the diameter of the operating part 3 at the transition thereof to the front area 4. In the present case, it is for example two fifth to one third of the diameter of the operating part.

The center surface area 5 of non-cutting configuration can consist of the same material as the operating part 3 of the respective preparation instrument. However, it is also possible to provide in the forwardly directed center of the free front end of the operating part 4, a recess for the installation therein of another material for example for forming the torpedo tip.

The invention is not limited to the three shown exemplary embodiments. Rather, various modifications are possible within the context of the invention.

What is claimed is:

1. A dental preparation instrument with a shaft part (1) and an adjacent operating part (3) with a cutting structure configured and adapted to the preparation of a tooth, the operating part (3) having a free front end area (4) with a non-cutting surface area (5) in the form of, in a top front view, central circular area, whose diameter is a fraction of the diameter of the operating part (3) at the transition location thereof to the front end area (4), the non-cutting surface area (5) and the adjacent surface area provided with the cutting structure steplessly fading into one another.

2. A preparation instrument according to claim 1, wherein the operating part (3) has the form of a cylinder or a cone.

3. A preparation instrument according to claim 2, wherein that the free front end (4) of the operating part (3) is formed as a convexly rounded tip in the so-called “classical torpedo” shape and has a central surface area (5) which is of non-cutting configuration has a spherical cover-like shape.

4. A preparation instrument according to claim 2, wherein the working part (3) has a planar front end area with a rounded circumferential edge and the non-cutting central surface area is circular.

5. A preparation instrument according to claim 2, wherein the front end area (4) of the operating part (3) is round and the central area (5) of non-cutting configuration has the form of a spherical cover.

6. A preparation instrument according to claim 1, wherein the operating part (3) of cutting configuration comprises a grinding medium coating (2).

7. A preparation instrument according to claim 6, wherein the grinding medium coating comprises at least one of diamonds, diamond splinters, hard metal, and hard metal splinters.

8. A preparation instrument according to claim 1, wherein the operating part (3) of cutting configuration is provided by cutter edges disposed on the operating part.

9. A preparation instrument according to claim 1, wherein the surface area provided for the non-cutting structure consists of a material different from that of which the operating part (3) consists.

10. A preparation instrument according to claim 9, wherein the material forming the non-cutting surface area is arranged in a recess formed centrally in the front end area of the operating part.
